(19) United States
(12) Patent Application Publication
(10) Pub. No.: US 2008/0031143 A1
(43) Pub. Date: Feb. 7, 2008

(54) Voice Over Internet Protocol (Voip) Quality Testing Over Hybrid Fiber/Coax (Hfc) Network

(75) Inventor: James R. Ostrosky, Gibsonia, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Tollgrade Communications, Inc., Wilmington, DE (US)

(21) Appl. No.: 11/629,137

(22) PCT Filed: Jun. 13, 2005
(86) PCT No.: PCT/US05/20850

§ 371 Date: Dec. 8, 2006

Related U.S. Application Data
(60) Provisional application No. 60/579,273, filed on Jun. 14, 2004.

(51) Int. Cl. G06F 11/07

(52) U.S. Cl. 370/242

(57) ABSTRACT

First and second test devices communicatively coupled to a hybrid fiber/coax (HFC) plant are operative for transmitting data packets of a simulated Voice over Internet Protocol (VoIP) telephone call therebetween without the use of a physical telephone at either test device. Each test device is operative for analyzing data packets received or transmitted thereby and for transmitting its analysis of the received or transmitted data packets to a call management system and a test controller.

### BACKGROUND OF THE INVENTION

1. Field of the Invention

The present invention relates to an apparatus and method for testing a Voice over Internet Protocol (VoIP) network and, more particularly, for testing the ability of the VoIP network to handle voice telephone calls.

2. Description of Related Art

Voice over Internet Protocol (VoIP) is the newest technology available for making telephone calls. Unlike the historical telephony technology, where each customer has dedicated wires running directly from their home or business to a central office or digital loop carrier (DLC) cabinet, VoIP relies on transmitting messages in data packets at high-speed using DOCSIS cable modems in the cable TV industry or DSL (Digital Subscriber Line) modems by existing telephony providers.

When using traditional copper-based telephony, phone calls are established between two telephones using analog signaling methods. This is performed by changing voltages, polarities and transmitting DTMF tones which are interpreted directly by the switch equipment in the central office. For example, to indicate a phone is off-hook, the “E” signal is connected to ground.

Since the physical wires and the analog signaling methods currently used by the copper technology are no longer available when using VoIP technology, the old analog style signals must be changed into messages transmitted in data packets over the high-speed network, then interpreted by VoIP switch equipment (ak.a. softswitch or call management system (CMS)), which is the equivalent of a CLASS switch for analog telephones. This conversion is done at customer premises by devices known as MTAs (multimedia terminal adapters) or EMTAs (embedded MTAs).

Various “message-based” signaling methods have been adopted to establish VoIP phone calls. Presently, the two most popular methods are the Media Gateway Control Protocol (MGCP) and the Session Initiation Protocol (SIP). For the Hybrid Fiber/Coax (HFC) plants found typically in the cable TV industry, the Network Call Signaling (NCS) protocol was developed, based on MGCP. Typically, when used, each of these protocols is an application layer that is superimposed on the well-known DOCSIS protocol which acts as the data-link layer for the MGCP, SIP or NCS protocol.

Regardless of the signaling method used, several problems remain to be solved before providers initiate widescale deployment. These include:
Correct, reliable provisioning. Part of the provisioning process is to associate, in the CMS, a phone number with the IP address assigned to a particular MTA. This association allows the message signaling to proceed.
Network impairments (delay, jitter, packet loss). These impairments affect all message traffic to and from a customer telephone, regardless of the type of message. In “normal” web browsing and e-mail, these impairments are usually not noticed since web browsing and e-mail are visual and non-time critical. However, voice traffic, e.g., VoIP telephone calls, have been proven to tolerate very specific limits before the human ear notices quality degradation.
Capacity planning. Unlike copper telephony where each user has a dedicated copper pair, a high-speed data network has specific bandwidth capacity. VoIP phone deployment must be monitored and compared to existing capacity to prepare for upgrades as needed.
Real-time debug of interaction issues. Unlike copper telephony, where physical signals can be measured, VoIP telephony is message based. Diagnostics of the messages and the interaction with the CMS requires special software and tools.
Hybrid Fiber/Coax (HFC) plant impairments. HFC systems suffer from noise ingress in the return path (as well as potentially some in the forward path). This return path ingress can cause packet loss resulting in call quality degradation from the originator. This can be extraordinarily difficult to diagnose, since a provider can only take the word of the person reporting the issue—by which time, the noise ingress may be gone.

Some of the above described problems can be solved on the network side by existing equipment.

Prior art devices are capable of performing the necessary measurements from the network side but, by their very nature, cannot account for or detect problems occurring in the final delivery to equipment at customer premises. Exceptions include equipment which is deployed as part of an actual telephone at small offices, where it is practical to do so. However, for the vast majority of HFC VoIP equipment, deployment is limited to households, not offices, rendering these locally-located devices impractical.

Another possible location for test equipment is at the central office, where it is generally more economical since a single piece of equipment can typically handle many hundreds or thousands of users. Line degradation on copper pairs that causes voice quality issues can be measured remotely using invasive analog methods. HFC VoIP systems, however, cannot be tested invasively due to the shared nature of the medium, i.e., a single coax cable, and thus require a new method of testing to correctly access the end-user's experience and identify problems. The prior art equipment in this situation is adequate to measure central office performance, but cannot emulate the equipment of an end-user due to its location.

What is, therefore, needed, and not disclosed in the prior art, is an apparatus and method for dual ended testing of a VoIP network. More particularly, what is needed is an apparatus and method for testing a VoIP network that does not require the use of physical telephones and related MTAs or EMTAs.

### SUMMARY OF THE INVENTION

The invention is a method of testing a VoIP network that includes a hybrid fiber/coax (HFC) plant having a plurality of communication paths, each of which includes a fiber optic plant having a first end communicatively coupled to a first coaxial cable plant via a first transceiver and a second end communicatively coupled to a second coaxial cable plant via a second transceiver. Each transceiver is configured to convert optical data signals into corresponding electrical data signals and vice versa The first coaxial cable plant of each communication path is communicatively coupled to a call management system (CMS) via a cable modem terminations system (CMTS) which is configured to convert electrical data signals conveyed thereto via at least one of the communication paths from a first communication protocol utilized on the communication paths to a second communication protocol utilized by the CMS and vice versa. The method includes (a) communicatively coupling a first test device assigned a unique IP address to the second coaxial cable of a first communication path; (b) communicatively coupling a second test device assigned a unique IP address to the second coaxial cable of a second communication path; (c) creating a communication session between the first and second devices via the first and second communication paths; (d) simulating without the use of a physical telephone a voice telephone call between the first and second test devices via the communication session, wherein said simulated telephone call includes conveying data packets from the first test device to the second test device and vice versa; (e) analyzing the data packets received at each test device; and (f) transmitting the analysis of the data packets received by each test device to the CMS.

The first communication protocol can be a DOCSIS protocol and the second communication protocol can be an Ethernet protocol.

Step (e) can include analyzing the data packets for packet arrival delay(s), jitter and packet loss.

The method can further include the first test device determining a time interval between its transmission of a message to the CMS and the arrival of a responsive message from the CMS. The first test device can convey the time interval to a test controller via the CMTS.

Step (d) can be initiated under the control of a test controller via the CMTS.

The method can further include, prior to creating the communication session, transmitting telephone numbers associated with the first and second test devices from the first test device to the CMS; determining at the CMS the unique IP address of the second test device corresponding to the telephone number for the second test device received from the first test device; transmitting the telephone number of the first test device to the unique IP address of the second test device; comparing at least a portion of the telephone number of the first test device received by the second test device to a reference pattern, e.g., a telephone number, stored at the second test device; and causing the communication session to be created or not to be created between the first and second test devices as a function of the comparison.

The invention is also a system for testing a VoIP network that includes a hybrid fiber/coax (HFC) plant having a plurality of coaxial cable/fiber-optic/coaxial cable communication paths, each of which is communicatively coupled via one of the coaxial cables thereof to a call management system (CMS). The system includes a first test device coupled to the other coaxial cable of a first communication path of the HFC plant and a second test device coupled to the other coaxial cable of a second communication path of the HFC plant. The test devices are operative for transmitting data packets of a simulated internet protocol (IP) telephone call therebetween via the first and second communication paths of the HFC plant without the use of a physical telephone at each test device. Each test device is operative for analyzing the data packets received thereby and for transmitting its analysis of the received data packets to the CMS.

A first communication protocol can be utilized for transmitting the data packets of the IP telephone call between the first and second test devices through the HFC plant. A second communication protocol can be utilized for transmitting the analysis of the data packets from the HFC plant to the CMS.

The system can also include means for converting transmissions from either test device intended for the CMS from the first communication protocol to the second communication protocol and for converting transmissions from the CMS intended for either test device from the second communication protocol to the first communication protocol.

The first test device can determine a time interval between the transmission of a message to the CMS and the arrival of a responsive message from the CMS.

The simulated IP telephone call can be initiated under the control of a test controller.

The first and second test devices can each have a unique IP address and a unique telephone number associated therewith. The test devices are operative for transmitting the data packets of the simulated IP telephone call via a communication session established therebetween. The first test device is operative for causing the unique telephone number associated with its unique IP address to be transmitted to the IP address of the second test device. The second test device is operative for establishing the communication session with the first test device in response to the second test device detecting or not detecting a match between at least a portion of the unique telephone number of the first test device and a reference pattern, e.g., a telephone number.

The invention is also a method of testing a VoIP network that includes a hybrid fiber/coax (HFC) plant having a communication path which includes a fiber optic plant having a first end communicatively coupled to a first coaxial cable plant via a first transceiver and a second end communicatively coupled to a second coaxial cable plant via a second transceiver. Each transceiver is configured to convert optical data signals into corresponding electrical data signals and vice versa. The first coaxial cable plant is communicatively coupled to a call management system (CMS) via a cable modem terminations system (CMTS) which converts electrical data signals conveyed thereto via the communication path from a first communication protocol utilized on the communication paths to a second communication protocol utilized by the CMS and vice versa. The method includes (a) communicatively coupling first and second test devices, each of which is assigned a unique IP address, to the second coaxial cable of the communication path; (b) causing the CMS to create a communication session between the first and second devices via the communication path; (c) simulating, without the use of a physical telephone, a voice telephone call between the first and second test devices via the communication session, wherein said simulated telephone call includes conveying data packets from the first test device to the second test device and vice versa, (d) analyzing the data packets received by each test device; and (e) transmitting the analysis of the data packets received by each test device to the CMS.

The method can further include the first test device determining a time interval between its transmission of a message to the CMS and the arrival of a responsive message from the CMS. The first test device can convey the time interval to a test controller via the CMTS.

Step (d) can be initiated under the control of a test controller via the CMTS.

The method can further include, prior to the creation of the communication session in step (b), transmitting telephone numbers associated with the first and second test devices from the first test device to the CMS; determining at the CMS the unique IP address of the second test device corresponding to the telephone number for the second test device received from the first test device; transmitting the telephone number of the first test device to the unique IP address of the second test device; comparing at least a portion of the telephone number of the first test device received by the second test device to a reference pattern, e.g., a telephone number, stored at the second test device; and causing the communication session to be created or not to be created between the first and second test devices as a function of the comparison.

Lastly, the invention is a system for testing a VoIP network that includes a hybrid fiber/coax (HFC) plant having a coaxial cable/fiber-optic/coaxial cable communication path which is communicatively coupled via one of the coaxial cables thereof to a call management system (CMS). The system includes a first test device coupled to the other coaxial cable of the communication path of the HFC plant and a second test device coupled to the other coaxial cable of the communication path of the HFC plant. The test devices are operative for transmitting data packets of a simulated internet protocol (IP) telephone call therebetween via the communication path without the use of a physical telephone at each test device. Each test device is operative for analyzing the data packets received thereby. Each test device is operative for transmitting its analysis of the received data packets to the CMS via the HFC plant.

A first communication protocol is utilized for transmitting the data packets of the IP telephone call between the first and second test devices. A second communication protocol is utilized for transmitting the analysis of the data packets from the HFC plant to the CMS.

The system includes means for converting transmissions from either test device intended for the CMS from the first communication protocol to the second communication protocol and for converting transmissions from the CMS intended for either test device from the second communication protocol to the first communication protocol.

The first test device can determine a time interval between the transmission of a message to the CMS and the arrival of a responsive message from the CMS.

The simulated IP telephone call can be initiated under the control of a test controller.

The first and second test devices can each have a unique IP address and a unique telephone number associated therewith. The test devices are operative for transmitting the data packets of the simulated IP telephone call via a communication session established therebetween. The first test device is operative for causing the unique telephone number associated with its unique IP address to be transmitted to the IP address of the second test device. The second test device is operative for establishing the communication session with the first test device in response to the second test device detecting or not detecting a match between at least a portion of the unique telephone number of the first test device and a reference pattern, e.g., a telephone number.

### BRIEF DESCRIPTION OF THE DRAWINGS

FIG. 1 is a block diagram of a VoIP network that includes a number of test devices for testing the capacity of the VoIP network to handle telephone calls; and

FIG. 2 is a diagram of a sequence of messages transmitted between an originating test device, a destination test device and/or a call management system (CMS) of the VoIP network shown in FIG. 1 to facilitate testing of at least a portion of the VoIP network between the originating test device and the destination test device.

### DETAILED DESCRIPTION OF THE INVENTION

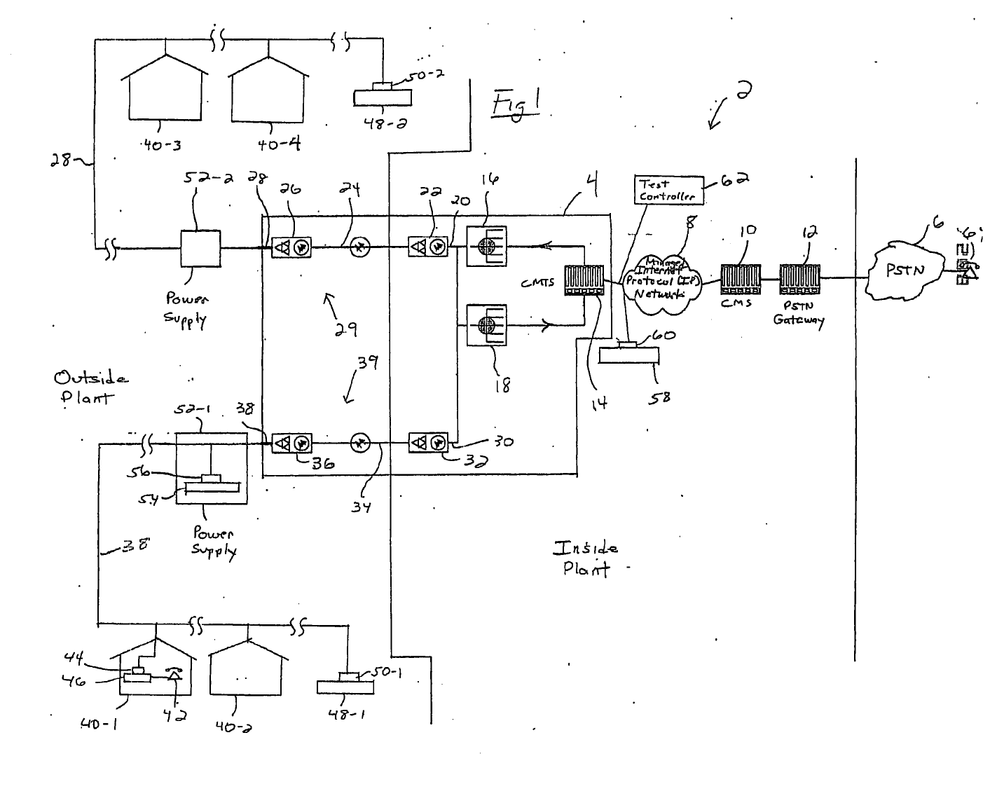

With reference to FIG. 1, an exemplary VoIP network 2 includes a hybrid fiber/coax (HFC) plant 4, that utilizes the well-known DOCSIS (or any other well-known and suitable) transport protocol, communicatively coupled to a public switched telephone network (PSTN) 6, which is not considered part of VoIP network 2, via a managed Internet protocol (IP) network 8, a call management system (CMS) 10 and a PSTN Gateway 12.

HFC plant 4 includes a cable modem termination system (CMTS) 14 communicatively coupled to IP network 8. HFC plant 4 also includes a forward path combiner 16, a return path splitter 18, coaxial cable plants 20, 28, 30 and 38, optical nodes (or transceivers) 22, 26, 32 and 36, and fiber optic plants 24 and 34 all connected as shown.

The combination of coaxial cable plant 20, optical node 22, fiber optic plant 24, optical node 26 and at least part of coaxial cable plant 28 comprises a first communication path 29 of HFC plant connected to forward path combiner 16 and return path splitter 18, while the combination of coaxial cable plant 30, optical node 32, fiber optic plant 34, optical node 36 and at least part of coaxial cable plant 38 comprises a second communication path 39 of HFC plant 4 that is connected to forward path combiner 16 and return path splitter 18.

The illustration of HFC plant 4 as having first and second communication paths 29 and 39, however, is not to be construed as limiting the invention since HFC plant 4 can have any number of communication paths, including only one communication path, as deemed necessary by one skilled in the art. Since the operation of CMTS 14, combiner 16, splitter 18 and optical nodes 22, 26, 32 and 36 are well-known in the art, details regarding each of their operation will not be described in detail herein.

Each coaxial cable plant 20, 28, 30 and 38 includes any suitable combination of coaxial cables and hardware deemed necessary by one skilled in the art in order to facilitate its function. Similarly, each fiber optic plant 24 and 34 includes any suitable combination of fiber optic cables and hardware deemed necessary by one skilled in the art in order to implement its function. Since the hardware necessary to implement each fiber optic plant 24 and 34, and each coaxial cable plant 20, 28, 30 and 38 can be readily selected by one skilled in the art, details regarding the specific implementation of each of these plants will not be described herein for the propose of simplicity.

VoIP network 2 desirably includes one or more customer premises, e.g., 40-1 and 40-2, each of which includes one or more telephones 42 communicatively coupled to coaxial cable plant 38 via a DOCSIS cable modem 44 and a multi-media terminal adapter (MTA) 46. MTA 46 can be omitted when DOCSIS cable modem 44 includes an embedded MTA (EMTA).

A test device 48-1 is coupled to coaxial cable plant 38 via a DOCSIS cable modem 50-1. In FIG. 1, test device 48-1 and DOCSIS cable modem 50-1 are shown connected on or near the terminal end of coaxial cable plant 38. However, this is not to be construed as limiting the invention since test device 48-1 and DOCSIS cable modem 50-1 can be connected to any desired point of coaxial cable plant 38. A power supply 52-1 is desirably coupled to coaxial cable plant 38 adjacent optical node 36. Power supply 52-1 is operative for supplying power to optical node 36 to facilitate the operation thereof. Desirably, power supply 52-1 includes a test device 54, similar to test device 48-1, which is communicatively coupled to coaxial cable plant 38 via a DOCSIS cable modem 56. Desirably, test device 54 and DOCSIS cable modem 56 are embedded and form part of power supply 52-1. However, this is not to be construed as limiting the invention.

Coaxial cable plant 38 can also be utilized to facilitate the connection of additional customer premises (not shown) to HFC plant 4 in the same manner that customer premises 40-1 and 40-2 are connected.

A power supply 52-2 is coupled to coaxial cable plant 28 adjacent optical node 26. Power supply 52-2 is operative for supplying power to optical node 26 to facilitate the operation thereof. Like power supply 52-1, power supply 52-2 includes a test device 54 coupled to coaxial cable via a DOCSIS cable modem 56. For purpose of simplicity, the test device 54 and the DOCSIS cable modem 56 of power supply 52-2 are not shown.

If desired, VoIP network 2 can also include one or more customer premises, e.g., 40-3 and 40-4, connected to coaxial cable plant 28. Each customer premise 40-3 and 40-4 connected to coaxial cable plant 28 can include the same hardware, e.g., one or more telephones 42, a DOCSIS cable modem 44, etc., as customer premise 40-1. Accordingly, this hardware is not shown in FIG. 1 for purpose of simplicity.

Lastly, a test device 48-2 can be connected on or adjacent the terminal end of coaxial cable plant 28 via a DOCSIS cable modem 50-2. Test device 48-2 and DOCSIS cable modem 50-2 are similar to test device 48-1 and DOCSIS cable modem 50-1.

Ethernet lines and the Ethernet protocol are utilized to communicatively connect CMTS 14, managed IP network 8, CMS 10 and PSTN Gateway 12. A test device 58 can be communicatively coupled to HFC plant 4 via one of these Ethernet lines and an Ethernet transceiver 60 which is typically embedded in test device 58. Lastly, an optional test controller 62 for initiating the operation of each test device in a manner to be described hereinafter can be communicatively coupled to HFC plant 4 via one of the Ethernet lines. The illustration of transceiver 60 and test controller 62 connected to the Ethernet line connecting HFC plant 4 and managed IP network 8 is not to be construed as limiting the invention since transceiver 60 and/or test controller 62 can be connected to any of the Ethernet lines connecting HFC plant 4, managed IP network 8, CMS 10 and PSTN Gateway 12 as deemed appropriate by one of ordinary skill in the art.

In FIG. 1, VoIP network 2 is illustrated as comprising an inside plant portion and an outside plant portion, each of which includes the corresponding illustrated hardware. In FIG. 1, PSTN 6 and any telephone connected directly thereto, e.g., telephone 64, is not considered part of VoIP network 2.

In normal operation of VoIP network 2, each telephone 42 that is associated with a unique IP address can participate in a telephone call with any other telephone 42 that is associated with a different, unique IP address or with any telephone 64 connected to VoIP network 2 via PSTN 6. Since the creation, maintenance and termination of telephone calls over VoIP network 2 is well-known in the art, details regarding the same will not be described herein for purpose of simplicity.

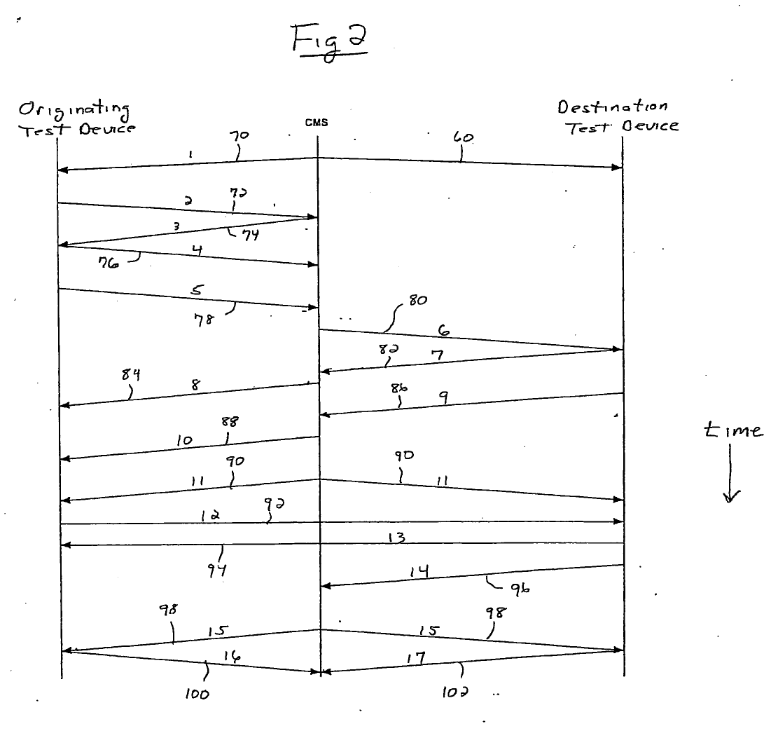

With reference to FIG. 2 and with continuing reference to FIG. 1, test devices 48, 54 and 58 can be communicatively paired together, e.g., (any 48 and any 54), (any 48 and 58) and (any 54 and 58), for testing the portion of VoIP network 2 therebetween. An exemplary, non-limiting example of the interaction between a pair of test devices and CMS 10 to create, maintain and terminate a communication session between said pair of test devices for the purpose of testing the portion of VoIP network 2 therebetween will now be described.

CMS 10 initially transmits a first message 70 to each test device 48, 54 and 58 of VoIP network 2. First message 70 includes one or more packets of data that request each test device to inform CMS 10 when the test device enters a simulated off-hook state. Since each test device does not include a physical telephone, when the test device enters the simulated off-hook state, no physical signal corresponding to the off-hook event is generated or sensed locally since there is no physical telephone. Accordingly, it is necessary when entering the simulated off-hook state, that each test device inform CMS 10 of the off-hook event by transmitting a corresponding message. For purpose of describing the present invention, it will be assumed hereinafter that each message includes one or more packets of data, each of which includes one or more data bits.

When an originating test device, e.g., test device 48-1, is directed, either via an external command received from test controller 62 or via an internal schedule, to make a call to the telephone number of a specific destination test device, e.g., test device 54 of power supply 52-2, the originating test device simulates an off-hook state and transmits to CMS 10 a second message 72 that informs CMS 10 that the originating test device is off-hook. The telephone number of the destination test device may be received from test controller 62 with the external command or may be preprogrammed within the originating test device. An obvious benefit of having test controller 62 provide the originating test device with the specific telephone number of the destination test device is that test devices can be paired together under the control of test controller 62 in any desired manner to facilitate the testing of the portion of VoIP network 2 therebetween.

In response to receiving second message 72, CMS 10 transmits a third message 74 to the originating test device. Third message 74 instructs the originating test device to create a connection to only CMS 10; to set itself (the originating test device) to a receive only mode; to indicate a dial tone signal can be provided; to inform CMS 10 when the originating test device returns to an on-hook state (after testing is complete); and that CMS 10 is standing by to receive the telephone number of the specific destination test device from the originating test device.

In response to receiving the dial tone instruction in third message 74, the originating test device indicates internally that the dial tone signal is present and transmits a fourth message 76 to CMS 10. Since the originating test device does not include any type of listening device, e.g., a telephone handset, the dial tone signal is simply an internal indication. Fourth message 76 includes the preferred media settings of the originating test device, e.g., SDP1. These preferred media settings include, without limitation, the session ID number, the preferred CODEC settings of the originating test device, packetization times, i.e., how often data packets are sent by the originating test device to CMS 10, and the like.

In response to detecting the internal indication that the dial tone signal is present, the originating test device generates an internal dialing simulation of the telephone number of the destination test device. This dialing simulation simulates the dialing sequence of a conventional telephone. The originating test device also transmits to CMS 10 a fifth message 78 that includes the telephone number of the destination test device. Since the originating test device does not include any type of listening device, the dialing simulation generated by the originating test device after transmission of fourth message 76 is simply an internal dialing simulation.

In response to receiving fifth message 78, CMS 10 searches a database that includes a list of reference patterns, such as, without limitation, one or more telephone numbers and corresponding IP addresses associated with the test devices of VoIP network 2. Based on a match between all or a portion of the telephone number of the destination test device received in fifth message 78 and a reference pattern of the destination test device stored in the database, CMS 10 retrieves the corresponding IP address of the destination test device from the database.

Thereafter, CMS 10 transmits a sixth message 80 to the IP address of the destination test device. Sixth message 80 includes the media settings (SDP1) and the IP address of the originating test device along with instructions for the destination test device to indicate a “ringing” signal can be provided, like the ringing signal generated by a conventional telephone, and to create a communication session with the originating test device at its IP address utilizing the originating test device's media settings (SDP1). Since the destination test device does not include any type of listening device, e.g., a telephone handset, the ringing signal is simply an internal indication.

In response to receiving sixth message 80, the destination test device transmits a seventh message 82 to CMS 10. Seventh message 82 instructs CMS 10 that the destination test device is prepared to establish a communication session. Seventh message 82 also includes the preferred media settings of the destination test device (SDP2).

In response to receiving seventh message 82, CMS 10 transmits an eighth message 84 to the originating test device. Eighth message 84 includes instructions for the originating test device to indicate a “ringback” signal can be provided, like the ringback signal that causes an audible “ringing” sound to be generated on the handset of a conventional telephone initiating a voice telephone call; the media settings of the destination test device (SDP2); and the IP address of the destination test device. Since the originating test device does not include any type of listening device, the ringback signal is simply an internal indication.

In response to receiving eighth message 84, the originating test device generates an internal indication of the ringing signal, like the ringing signal of a conventional telephone. Since the originating test device does not include any type of listening device, the ringing signal is simply an internal indication.

After transmitting seventh message 82, and in response to the ringing indication, the destination test device may, after a brief, optional pause, simulate an off-hook event and transmits to CMS 10 a ninth message 86 that indicates to CMS 10 that the destination test device is in its off-hook state.

In response to receiving ninth message 86, CMS 10 transmits a tenth message 88 to the originating test device. This tenth message includes the media settings of the destination test device (SDP2); instructions for the originating test device to switch from the receive only mode to a transmit/receive mode; to initiate the communication session with the destination test device utilizing the media settings of the destination test device (SDP2); and to terminate the ringback signal.

Next, CMS 10 transmits to both the originating test device and the destination test device an eleventh message 90 that instructs each test device to notify CMS 10 when it assumes an on-hook state (upon completion of the communication session therebetween).

In response to receiving eleventh message 90, the originating test device establishes a communication session directly with the destination test device utilizing the IP address and the media setting of the destination test device received by the originating test device in eighth message 84 and transmits a twelfth message 92, which, in practice, is the combination of a media (voice) message 92-M and a separate measurement message 92-R, repeatedly to the destination test device for a predetermined time interval, e.g., between thirty seconds and one hour. After this predetermined time interval expires, the originating test device terminates twelfth message 92.

In response to receiving eleventh message 90, the destination test device establishes a communication session directly with the originating test device utilizing the IP address and the media settings of the originating test device received by the destination test device in sixth message 80 and transmits a thirteenth message 94, which, in practice, is the combination of a media (voice) message 94-M and a measurement message 94-R, repeatedly to the originating test device for a predetermined time interval. The predetermined time interval of the thirteenth message 94 can be the same or different than the predetermined time interval of the twelfth message 92. Thirteenth message 94 may be transmitted by the destination test device concurrent with or following the transmission of twelfth message 92 by the originating test device, or vice versa Thirteenth message 94 is the destination test device's equivalent of the twelfth message 92 transmitted by the originating test device. It is not necessary, however, that twelfth message 92 and thirteenth message 94 be identical.

In a conventional VoIP telephone call, analog voice signals are converted into digital signals which are then encoded by suitable circuitry into a suitable codec format, e.g., G.711. In accordance with the present invention, media messages. 92-M and 94-M are both voice messages that are pre-encoded in the codec format being utilized for the communication session. Hence, codec formatted digital audible data resides on both the originating test device and the destination test device for transmission during a communication session established therebetween.

Upon expiration of the predetermined time interval for transmitting the twelfth message 92 or the thirteenth message 94, whichever occurs first, the respective originating test device or destination test device simulates an on-hook event and transmits a fourteenth message 96 to CMS 10 that informs CMS 10 that the destination test device is in its on-hook state. For purpose of describing the present invention it will be assumed that the predetermined time interval for the destination test device to transmit thirteenth message 94 has expired, whereupon the destination test device transmits fourteenth message 96 to CMS 10. However, this is not to be construed as limiting the invention

In response to receiving fourteenth message 96, CMS 10 transmits to the originating test device and the destination test device a fifteenth message 98 that instructs each test device to terminate its connection and, hence, the communication session.

In response to receiving fifteenth message 98, the originating test device simulates an on-hook event and transmits a sixteenth message 100 to CMS 10 that includes an indication that the originating test device is on-hook along with various performance data determined by the originating test device during the transmission of the twelfth message 92 and/or the receipt of the thirteenth message 94.

Similarly, in response to receiving fifteenth message 98, the destination test device transmits a seventeenth message 102 to CMS 10 that includes an indication that the destination test device is on-hook along with various performance data determined by the destination test device during receipt of the twelfth message 92 and/or transmission of the thirteenth message 94.

In response to receiving the fifteenth message 98, each test device also terminates the connection and, hence, the communication session with the other test device.

In the foregoing description, the connection and, hence, the communication session between the originating test device and the destination test device was terminated in an orderly manner. However, it is to be appreciated that the use of other methods for terminating the connection/communication session between the originating test device and the destination test device may be provided in the event of an error occurring at the originating test device an/or the test destination test device. For purpose of simplicity, these other termination methods will not be described herein.

The performance data received by CMS 10 from each test device in sixteenth and seventeenth message 100 and 102 can include data regarding packet arrival delay(s), jitter, i.e., variation in packet arrival delays, and packet loss, i.e., a measure of the non-arrival of one or more packets of data. The measurement data transmitted from the originating test device to the destination test device, and/or vice versa, can include, without limitation, loss rate, discard rate, burst density, gap density, burst duration, gap duration, round-trip delay, system delay, signal level, noise level, minimum gain, and the like. This list of measurement data, however, is not to be construed as limiting the invention.

If desired, the originating test device can be configured to measure an interval of time between its transmission of second message 72 and its receipt of third message 74 from CMS 10 and/or an interval of time between its transmission of fifth message 78 and its receipt of eighth message 74 from CMS 10. If the originating test device determines either one or both of these intervals of time, at a suitable time after transmitting sixteenth message 100, the originating test device can transmit any such interval of time to test controller 62 for storage and/or retrieval by an user of test controller 62.

Where an originating test device is connected to one communication path of HFC plant 4, e.g., communication path 29, and the destination test device is connected to another communication path of HFC plant 4, e.g., communication path 39, the performance data transmitted to CMS 10 in the sixteenth and seventeenth messages 100 and 102 represent real-time, albeit temporal measurements of the performance of the overall communication path between the test devices, which in this case includes HFC plant 4. Thus, by virtue of installing suitable test devices to coaxial cable plants 28 and 38 of HFC plant 4, measurements of the ability of the hardware and lines of HFC plant 4 to handle telephone calls can be determined without the need for a physical telephone at each end or a user to initiate or answer calls.

The foregoing description of testing the ability of VoIP network 2 to handle a simulated telephone call between a pair of test devices connected to different communication paths of HFC plant 2 is not to be construed as limiting the invention since it is envisioned that similar testing can be conducted between any pair of test devices. For example, test device 54 of power supply 52-2 and test device 48-2 can establish a communication session therebetween in the manner described above for testing the ability of the portion of coaxial cable plant 28 therebetween to handle telephone calls without the use of a physical telephone or a user to initiate or answer calls.

Moreover, although test device 58 is connected to HFC plant 4 via an Ethernet line, test device 58 can be paired with any test device 54 or 48 in the manner described above for testing the ability of the portion of the VoIP network 2 therebetween to handle telephone calls without the use of a physical telephone or a user to initiate or answer calls.

The present invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of testing a VoIP network that includes a hybrid fiber/coax (HFC) plant having a plurality of communication paths, each of which includes a fiber optic plant having a first end communicatively coupled to a first coaxial cable plant via a first transceiver and a second end communicatively coupled to a second coaxial cable plant via a second transceiver, each transceiver configured to convert optical data signals into corresponding electrical data signals and vice versa, the first coaxial cable plant of each communication path communicatively coupled to a call management system (CMS) via a cable modem terminations system (CMTS) which is configured to convert electrical data signals conveyed thereto via at least one of the communication paths from a first communication protocol utilized on the communication paths to a second communication protocol utilized by the CMS and vice versa, the method comprising:
(a) communicatively coupling a first test device assigned a unique IP address to the second coaxial cable of a first communication path;
(b) communicatively coupling a second test device assigned a unique IP address to the second coaxial cable of a second communication path, wherein at least one of the first and second test devices is coupled to its communication path at or adjacent the connection of a power supply of the HFC plant to the communication path;
(c) creating a packet communication session between the first and second devices via the first and second communication paths;
(d) simulating without the use of a physical telephone a voice telephone call between the first and second test devices via the communication session, wherein said simulated telephone call includes conveying data packets from the first test device to the second test device and vice versa;
(e) analyzing the data packets received at each test device; and
(f) transmitting the analysis of the data packets received by each test device to the CMS.

2. The method of claim 1, wherein:
the first communication protocol is a DOCSIS protocol; and
the second communication protocol is an Ethernet protocol.

3. The method of claim 1, wherein step (e) includes analyzing the data packets for at least one of:
packet arrival delay(s);
jitter; and
packet loss, wherein jitter is a measure of variation(s) in packet arrival delay(s) and packet loss is a measure of the non-arrival of one or more packets.

4. The method of claim 1, further including:
the first test device determining a time interval between its transmission of a message to the CMS and the arrival of a responsive message from the CMS; and
the first test device conveying the time interval to a test controller via the CMTS.

5. The method of claim 1, wherein step (d) is initiated under the control of a test controller via the CMTS.

6. The method of claim 1, further including, prior to creating the communication session:
transmitting telephone numbers associated with the first and second test devices from the first test device to the CMS;
determining at the CMS the unique IP address of the second test device corresponding to the telephone number for the second test device received from the first test device;
transmitting the telephone number of the first test device to the unique IP address of the second test device;
comparing at least a portion of the telephone number of the first test device received by the second test device to a reference pattern stored at the second test device; and
causing the communication session to be created or not to be created between the first and second test devices as a function of the comparison.

7. A system for testing a VoIP network that includes a hybrid fiber/coax (HFC) plant having a plurality of coaxial cable/fiber-optic/coaxial cable communication paths, each of which is communicatively coupled via one of the coaxial cables thereof to a call management system (CMS), the system comprising:
a first test device coupled to the other coaxial cable of a first communication path of the HFC plant; and
a second test device coupled to the other coaxial cable of a second communication path of the HFC plant, wherein:
at least one of the first and second test devices is coupled to its communication path at or adjacent the connection of a power supply of the HFC plant to the communication path;
the test devices are operative for transmitting data packets of a simulated internet protocol (IP) telephone call therebetween via the first and second communication paths of the HFC plant without the use of a physical telephone at each test device;
each test device is operative for analyzing the data packets received thereby; and
each test device is operative for transmitting its analysis of the received data packets to the CMS.

8. The system of claim 7, wherein analyzing the data packets includes determining at least one of:
packet arrival delay(s);
jitter; and
packet loss, wherein jitter is a measure of variation(s) in packet arrival delay(s) and packet loss is a measure of the non-arrival of one or more packets.

9. The system of claim 7, wherein:
a first communication protocol is utilized for transmitting the data packets of the IP telephone call between the first and second test devices through the HFC plant;
a second communication protocol is utilized for transmitting the analysis of the data packets from the HFC plant to the CMS; and
the system includes means for converting transmissions from either test device intended for the CMS from the first communication protocol to the second communication protocol and for converting transmissions from the CMS intended for either test device from the second communication protocol to the first communication protocol.

10. The system of claim 7, wherein the first test device determines a time interval between the transmission of a message to the CMS and the arrival of a responsive message from the CMS.

11. The system of claim 7, wherein the simulated IP telephone call is initiated under the control of a test controller.

12. The system of claim 7, wherein:
the first and second test devices each have a unique IP address and a unique telephone number associated therewith;
the test devices are operative for transmitting the data packets of the simulated IP telephone call via a communication session established therebetween;
the first test device is operative for causing the unique telephone number associated with its unique IP address to be transmitted to the IP address of the second test device; and
the second test device is operative for establishing the communication session with the first test device in response to the second test device detecting or not detecting a match between at least a portion of the unique telephone number of the first test device and a reference pattern.

13. A method of testing a VoIP network that includes a hybrid fiber/coax (HFC) plant having a communication path which includes a fiber optic plant having a first end communicatively coupled to a first coaxial cable plant via a first transceiver and a second end communicatively coupled to a second coaxial cable plant via a second transceiver, each transceiver configured to convert optical data signals into corresponding electrical data signals and vice versa, the first coaxial cable plant communicatively coupled to a call management system (CMS) via a cable modem terminations system (CMTS) which converts electrical data signals conveyed thereto via the communication path from a first communication protocol utilized on the communication paths to a second communication protocol utilized by the CMS and vice versa, the method comprising:
(a) communicatively coupling first and second test devices, each of which is assigned a unique IP address, to the second coaxial cable of the communication path;
(b) causing the CMS to create a packet communication session between the first and second devices via the communication path, wherein at least one of the first and second test devices is coupled to its communication path at or adjacent the connection of a power supply of the HFC plant to the communication path;
(c) simulating without the use of a physical telephone a voice telephone call between the first and second test devices via the communication session, wherein said simulated telephone call includes conveying data packets from the first test device to the second test device and vice versa;
(d) analyzing the data packets received by each test device; and
(e) transmitting the analysis of the data packets received by each test device to the CMS.

14. The method of claim 13, wherein step (e) includes analyzing the data packets for at least one of:
packet arrival delay(s);
jitter; and
packet loss, wherein jitter is a measure of variation(s) in packet arrival delay(s) and packet loss is a measure of the non-arrival of one or more packets.

15. The method of claim 13, further including:
the first test device determining a time interval between its transmission of a message to the CMS and the arrival of a responsive message from the CMS; and
the first test device conveying the time interval to a test controller via the CMTS.

16. The method of claim 13, wherein step (d) is initiated under the control of a test controller via the CMTS.

17. The method of claim 13, further including, prior to the creation of the communication session in step (b):
transmitting telephone numbers associated with the first and second test devices from the first test device to the CMS;
determining at the CMS the unique IP address of the second test device corresponding to the telephone number for the second test device received from the first test device;
transmitting the telephone number of the first test device to the unique IP address of the second test device;
comparing at least a portion of the telephone number of the first test device received by the second test device to a reference pattern stored at the second test device; and
causing the communication session to be created or not to be created between the first and second test devices as a function of the comparison.

18. A system for testing a VoIP network that includes a hybrid fiber/coax (HFC) plant having a coaxial cable/fiber-optic/coaxial cable communication path which is communicatively coupled via one of the coaxial cables thereof to a call management system (CMS), the system comprising:
a first test device coupled to the other coaxial cable of the communication path of the HFC plant; and
a second test device coupled to the other coaxial cable of the communication path of the HFC plant, wherein:
at least one of the first and second test devices is coupled to its communication path at or adjacent the connection of a power supply of the HFC plant to the communication path;
the test devices are operative for transmitting data packets of a simulated internet protocol (IP) telephone call therebetween via the communication path without the use of a physical telephone at each test device;
each test device is operative for analyzing the data packets received thereby; and
each test device is operative for transmitting its analysis of the received data packets to the CMS via the HFC plant.

19. The system of claim 18, wherein analyzing the data packets includes determining at least one of:
packet arrival delay(s);
jitter; and
packet loss, wherein jitter is a measure of variation(s) in packet arrival delay(s) and packet loss is a measure of the non-arrival of one or more packets.

20. The system of claim 18, wherein:
a first communication protocol is utilized for transmitting the data packets of the IP telephone call between the first and second test devices;
a second communication protocol is utilized for transmitting the analysis of the data packets from the HFC plant to the CMS; and
the system includes means for converting transmissions from either test device intended for the CMS from the first communication protocol to the second communication protocol and for converting transmissions from the CMS intended for either test device from the second communication protocol to the first communication protocol.

21. The system of claim 18, wherein the first test device determines a time interval between the transmission of a message to the CMS and the arrival of a responsive message from the CMS.

22. The system of claim 18, wherein the simulated IP telephone call is initiated under the control of a test controller.

23. The system of claim 18, wherein:
the first and second test devices each have a unique IP address and a unique telephone number associated therewith;
the test devices are operative for transmitting the data packets of the simulated IP telephone call via a communication session established therebetween;
the first test device is operative for causing the unique telephone number associated with its unique IP address to be transmitted to the IP address of the second test device;
the second test device is operative for establishing the communication session with the first test device in response to the second test device detecting or not detecting a match between at least a portion of the unique telephone number of the first test device and a reference pattern.
